(19) United States
(12) Patent Application Publication
(10) Pub. No.: US 2015/0358765 A1
(43) Pub. Date: Dec. 10, 2015

(54) SECURING A MOBILE DEVICE BY BINDING TO AN ITINERARY

(71) Applicant: International Business Machines Corporation, Armonk, NY (US)

(72) Inventors: Gary D. Cudak, Creedmoor, NC (US); Christopher J. Hardee, Raleigh, NC (US); Adam Roberts, Moncure, NC (US)

(21) Appl. No.: 14/300,717

(22) Filed: Jun. 10, 2014

(51) Int. Cl. H04W 4/02; H04W 8/22

(52) U.S. Cl. CPC H04W 4/02; H04W 8/22

(57) ABSTRACT

A computer program product includes a computer readable storage medium having program instructions embodied therewith, wherein the program instructions are executable by a processor to cause the processor to perform a method. The method includes storing an itinerary in memory of an electronic device, wherein the itinerary includes a plurality of destinations and a time period associated with each destination. The method further includes monitoring the location of the electronic device, comparing the location of the electronic device to the itinerary, and restricting use of the electronic device in response to determining that the location of the electronic device at the current time does not match the destination specified in the itinerary for the time period that includes the current time.

### BACKGROUND

1. Field of the Invention

The present invention relates to preventing unauthorized use of an electronic device, such as a mobile phone or a computer.

2. Background of the Related Art

Mobile communication devices, such as telephones and laptop computers, or other electronic devices are an integral part of everyday life in a modern society. Telephones that are connected to a land line are even on the decline, as people become accustomed to having a mobile phone with them at all times. The functions and features available on a mobile phone continue to expand, including apps, a web browser, a camera, full physical or virtual keypads, touchscreens, Wi-Fi and Bluetooth connectivity, texting and email, and more.

Furthermore, an electronic device may store private information, such as pictures, passwords, payment information and other information that a user may not want shared. Security measures may be implemented on the mobile communication device in order to prevent others from gaining access to the private information or otherwise using the features of the device without authorization. Such security measures may include successful entry of a previously stored password or biometric input, such as facial recognition or finger print recognition. Furthermore, the strength of a password may be increased by requiring more characters and a variety of character types. For example, some security systems will require that a password include a minimum of eight characters, including at least one capital letter, one number and one special character.

### BRIEF SUMMARY

One embodiment of the present invention provides a computer program product comprising a computer readable storage medium having program instructions embodied therewith, wherein the program instructions are executable by a processor to cause the processor to perform a method comprising storing an itinerary in memory of an electronic device, wherein the itinerary includes a plurality of destinations and a time period associated with each destination. The method further comprises monitoring the location of the mobile communication device, comparing the location of the mobile communication device to the itinerary, and restricting use of the mobile communication device in response to determining that the location of the mobile communication device at the current time does not match the destination specified in the itinerary for the time period that includes the current time.

### BRIEF DESCRIPTION OF THE SEVERAL VIEWS OF THE DRAWINGS

FIG. 1 is a diagram of an electronic device in the form of a mobile communication device.

FIG. 2 is a table illustrating an itinerary.

FIG. 3 is a flowchart of a method in accordance with one embodiment of the present invention.

### DETAILED DESCRIPTION

One embodiment of the present invention provides a method, comprising storing an itinerary in memory of an electronic device, wherein the itinerary includes a plurality of destinations and a time period associated with each destination. The method further comprises monitoring the location of the electronic device, comparing the location of the electronic device to the itinerary, and restricting use of the electronic device in response to determining that the location of the electronic device at the current time does not match the destination specified in the itinerary for the time period that includes the current time.

As stated above, the itinerary includes a plurality of destinations and a time period associated with each destination. The time period associated with at least one of the destinations may be specified in various ways, such as a length of time or a particular calendar date, start time and end time. Furthermore, the itinerary may be obtained in various manners. For example, the itinerary may be received through manual input from a user, perhaps directly into a security application or utility on the electronic device. As a second example, the itinerary may be received by accessing a calendar that maintains the itinerary, such as a calendar program used by the same user that owns the electronic device. Optionally, the user calendar may be originally input into a different device or online service, then synchronized to the electronic device.

The location of the electronic device may be monitored in any of one or more ways. For example, the location of the electronic device may be monitored by receiving signals from a global positioning system, such that the location may be identified by values of latitude and longitude or their equivalents. In another example, monitoring the location of the electronic device may include detecting wireless network access points. In other words, as the electronic device is moved from place to place, the electronic device discovers different wireless network access points that may be used to identify or infer the location of the electronic device. While it is preferable for the electronic device to monitor its own location, certain embodiments may include the electronic device querying a third party service for information about the location of a wireless network access point or similar information. Optionally, the electronic device may be a mobile communication device, such as a mobile phone or a laptop computer.

In various embodiments, the location of the electronic device may be compared to the itinerary at regular intervals, continuously, in response to detecting a change in the location of the electronic device, or in response to the itinerary indicating that the electronic device is expected to be in a new destination. Optionally, the location of the electronic device may be determined to match the destination specified in the itinerary for the time period that includes the current time if the location is within a range of distance from the specified destination. In a further option, the location of the electronic device is determined to match the destination specified in the itinerary for the time period that includes the current time if the location matches one of the destinations specified in the itinerary within a range of time.

The use of the electronic device may be restricted in various manners, such as powering off or preventing power up of the electronic device, preventing login attempts, preventing use of one or more applications or functions of the electronic device, preventing changes to settings, requiring increased authentication in order to use one or more applications or functions of the electronic device, or combinations thereof. Where the use of the electronic device has been restricted by preventing login attempts, the method may later allow login attempts on the electronic device in response to the location of the electronic device matching a predetermined home location. Similarly, the method may restore normal use of the electronic device in response to the location of the electronic device matching a predetermined home location. Presumably, only an authorized user will know or have access to the predetermined home location.

In another option, the electronic device may automatically execute a predetermined task in response to determining that the location of the electronic device at the current time does not match the destination specified in the itinerary for the time period that includes the current time. Non-limiting examples of the predetermined task include sending a message to a user-specified device identifying the location of the electronic device and wiping information from the electronic device.

Another embodiment of the present invention provides a computer program product comprising a computer readable storage medium having program instructions embodied therewith, wherein the program instructions are executable by a processor to cause the processor to perform a method comprising storing an itinerary in memory of an electronic device, wherein the itinerary includes a plurality of destinations and a time period associated with each destination. The method further comprises monitoring the location of the electronic device, comparing the location of the electronic device to the itinerary, and restricting use of the electronic device in response to determining that the location of the electronic device at the current time does not match the destination specified in the itinerary for the time period that includes the current time.

The foregoing computer program products may further include computer readable program code for implementing or initiating any one or more aspects of the methods described herein. Accordingly, a separate description of the methods will not be duplicated in the context of a computer program product.

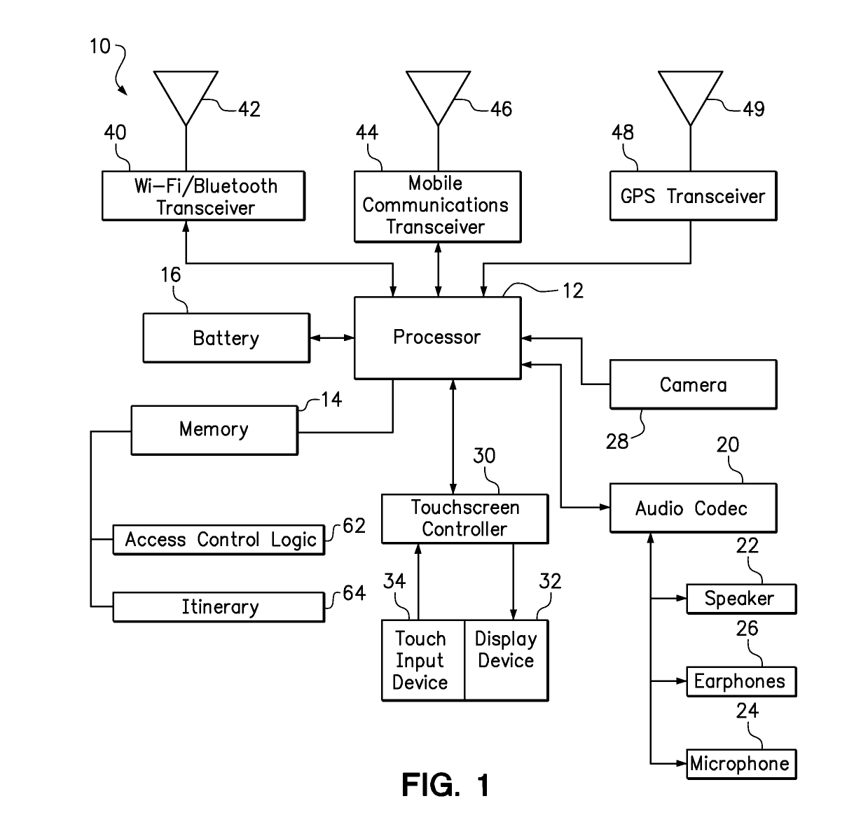

FIG. 1 is a diagram of components in one embodiment of an electronic device 10, such as a smart phone or laptop computer, capable of implementing embodiments of the present invention. The electronic device 10 may include a processor 12, memory 14, a battery 16, and an audio codec 20 coupled to a speaker 22, a microphone 24, and an earphone jack 26. The electronic device 10 may further include a camera 28, and a touchscreen controller 30 that provides a graphical output to the display device 32 and an input from a touch input device 34. Collectively, the display device 32 and touch input device 34 may be referred to as a touchscreen.

The electronic device 10 may also include a Wi-Fi and/or Bluetooth transceiver 40 and corresponding antenna 42 allowing the device to discover and communicate with a Bluetooth device or a Wi-Fi router, a mobile communication transceiver 44 and corresponding antenna 46 allowing the device to communicate over a mobile/cellular network, and a global positioning system (GPS) transceiver 48 and corresponding antenna 49 allowing the device to obtain signals from a global positioning system or satellites. As shown, the memory 14 stores an access control logic module 62, and an itinerary 64, which may optionally be stored in association with a calendar application. Aspects of the electronic device 10 that implement the present invention may be included in other electronic devices that may not be traditionally considered as being mobile, such computer servers, data storage devices, or automobile control systems and the like.

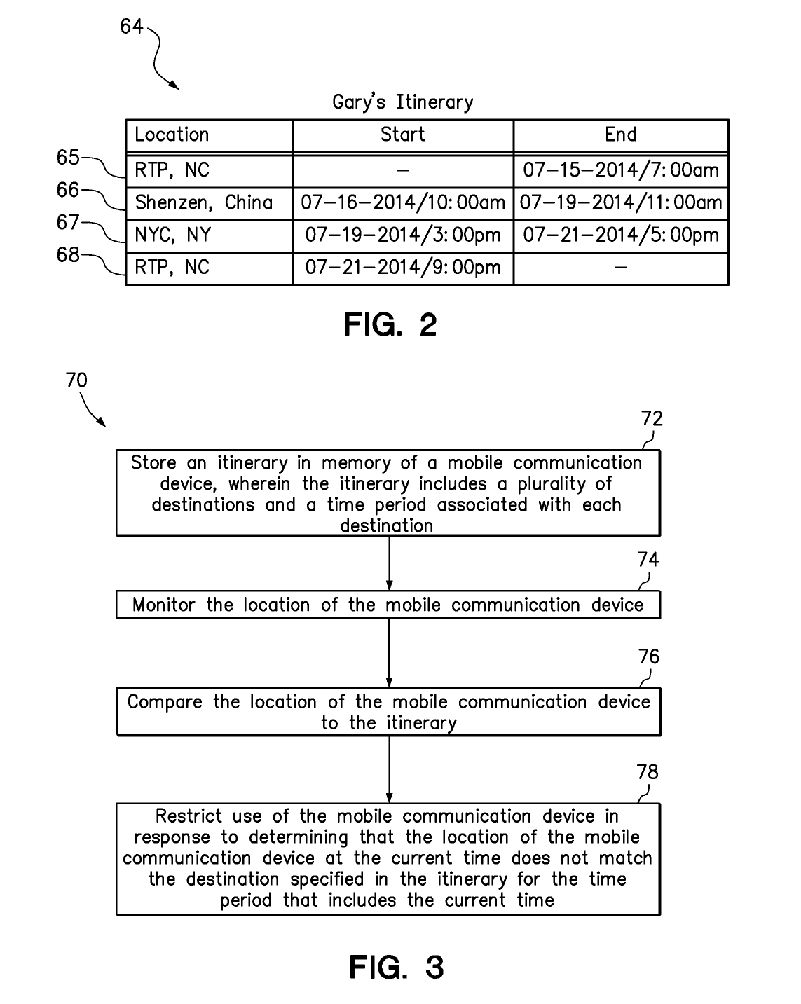

FIG. 2 is a table illustrating a non-limiting example of itinerary 64. In this example, Gary is going to take his laptop computer on a business trip that involves three days in Shenzen, China and then two days in New York City. Gary manually inputs and stores the itinerary in a security utility of the laptop computer, where the itinerary 64 includes locations and a time period associated with each location. Alternatively, Gary may manually input the itinerary into a calendar program and then sync the calendar to the security utility of the laptop computer. Gary also instructs the security utility to power off or prevent power up of the laptop computer if the location of the laptop computer does not follow the itinerary.

As shown, this example of the itinerary 64 includes four locations and a time period associated with each of the four locations. Each location and associated time period is illustrate as a row or record of a table, but any other data structure is suitable. In the first row 65, the itinerary shows that Gary and his laptop are expected to depart RTP, NC on Jul. 15, 2014 at 7:00 am. In the second row 66, the itinerary shows that Gary and his laptop are expected to be in Shenzen, China from Jul. 16, 2014 at 10:00 am to Jul. 19, 2014 at 11:00 am (local time in China). The third row 67 of the itinerary shows that Gary and his laptop are expected to be in NYC, NC from Jul. 19, 2014 at 3:00 pm to Jul. 21, 2014 at 5:00 pm (local time in NY). Then, the fourth row 68 of the itinerary shows that Gary and his laptop are expected to return to RTP, NC on Jul. 21, 2014 at 9:00 pm. Having entered this itinerary into the memory of the laptop, Gary is prepared to take the trip that begins on Jul. 15, 2014.

After Gary has completed the China portion of the trip without any incidents, he accidentally leaves his laptop computer in the airport in China as he boards an airplane for New York City on Jul. 19, 2014 around 11:00 am (local time in China). The laptop computer is found by an individual who attempts to use the laptop computer. However, the security utility of the laptop computer determines that the laptop computer is still in China rather than en route to New York City as specified in the itinerary. Accordingly, the security utility may take steps to limit use of the laptop computer, perhaps according to user settings selected by Gary. For example, the security utility may prevent the laptop computer from being powered up or limit the operable functions of the laptop computer.

FIG. 3 is a flowchart of a method 70 in accordance with one embodiment of the present invention. In step 72, the method stores an itinerary in memory of an electronic device, wherein the itinerary includes a plurality of destinations and a time period associated with each destination. Step 74 monitors the location of the electronic device, and step 76 compares the location of the electronic device to the itinerary. Then, step 78 restricts use of the electronic device in response to determining that the location of the electronic device at the current time does not match the destination specified in the itinerary for the time period that includes the current time.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer program product comprising a computer readable storage medium having program instructions embodied therewith, the program instructions executable by a processor to cause the processor to perform a method comprising:
storing an itinerary in memory of an electronic device, wherein the itinerary includes a plurality of destinations and a time period associated with each destination;
monitoring the location of the electronic device;
comparing the location of the electronic device to the itinerary; and
restricting use of the electronic device in response to determining that the location of the electronic device at the current time does not match the destination specified in the itinerary for the time period that includes the current time.

2. The computer program product of claim 1, the method further comprising:
receiving the itinerary through manual input from a user.

3. The computer program product of claim 1, the method further comprising:
accessing a calendar that maintains the itinerary.

4. The computer program product of claim 1, wherein the time period associated with at least one of the destinations is specified by a length of time.

5. The computer program product of claim 1, wherein the time period associated with at least one of the destinations is specified by a calendar date, start time and end time.

6. The computer program product of claim 1, wherein monitoring the location of the electronic device includes receiving signals from a global positioning system.

7. The computer program product of claim 1, wherein monitoring the location of the electronic device includes detecting wireless network access points.

8. The computer program product of claim 1, wherein comparing the location of the electronic device to the itinerary includes comparing the location of the electronic device to the itinerary at regular intervals.

9. The computer program product of claim 1, wherein comparing the location of the electronic device to the itinerary includes continuously comparing the location of the electronic device to the itinerary.

10. The computer program product of claim 1, wherein the location of the electronic device is determined to match the destination specified in the itinerary for the time period that includes the current time if the location is within a range of distance from the specified destination.

11. The computer program product of claim 1, wherein the location of the electronic device is determined to match the destination specified in the itinerary for the time period that includes the current time if the location matches one of the destinations specified in the itinerary within a range of time.

12. The computer program product of claim 1, wherein restricting use of the electronic device includes powering off the electronic device.

13. The computer program product of claim 1, wherein restricting use of the electronic device includes preventing login attempts.

14. The computer program product of claim 13, the method further comprising:
after preventing login attempts, allowing login attempts on the electronic device in response to the location of the electronic device matching a predetermined home location.

15. The computer program product of claim 1, wherein restricting use of the electronic device includes preventing use of one or more applications or functions of the electronic device.

16. The computer program product of claim 1, wherein restricting use of the electronic device includes preventing changes to settings.

17. The computer program product of claim 1, the method further comprising:
restoring normal use of the electronic device in response to the location of the electronic device matching a predetermined home location.

18. The computer program product of claim 1, wherein restricting use of the electronic device includes requiring increased authentication in order to use one or more applications or functions of the electronic device.

19. The computer program product of claim 1, the method further comprising:
the electronic device automatically executing a predetermined task in response to determining that the location of the electronic device at the current time does not match the destination specified in the itinerary for the time period that includes the current time.

20. The computer program product of claim 19, wherein the predetermined task is selected from sending a message identifying the location of the electronic device and wiping information from the electronic device.
